(19) United States
(12) Patent Application Publication
(10) Pub. No.: US 2014/0004534 A1
(43) Pub. Date: Jan. 2, 2014

(54) DETECTION OF ANALYTES IN HAIR WASH SAMPLES

(71) Applicant: Psychemedics Corporation, Acton, MA (US)

(72) Inventors: Virginia Hill, Los Angeles, CA (US); Michael I. Schaffer, Los Angeles, CA (US)

(21) Appl. No.: 13/931,169

(22) Filed: Jun. 28, 2013

Related U.S. Application Data
(60) Provisional application No. 61/665,790, filed on Jun. 28, 2012.

(51) Int. Cl. G01N 21/64

(52) U.S. Cl. CPC G01N 21/6486
USPC 435/7.9; 436/501

(57) ABSTRACT

Compositions and methods for detecting the presence and/or amount of one or more analytes, including analytes such as drugs of abuse in a hair wash sample are provided. The compositions include two or more analytes associated with a solid phase, e.g., a particle or a multiwell plate. The compositions and methods also allow the simultaneous, tandem, or serial determination of the presence and/or amount of two or more analytes of interest in a hair wash sample.

### CROSS-REFERENCE TO RELATED APPLICATIONS

This application claims priority to U.S. Provisional Application Ser. No. 61/665,790, filed on Jun. 28, 2012.

### TECHNICAL FIELD

This disclosure relates to methods and compositions for determining the presence and/or amount of one or more analytes (e.g., drugs of abuse, toxic chemicals, prescription medicines) in a hair wash sample, and more particularly to methods and compositions for doing the same using competitive immunoassays, such as enzyme immunoassays. In some embodiments, the methods and compositions can be used to determine the presence and/or amount of two or more analytes in a sample simultaneously, in tandem, or serially. Solid phase analyte compositions comprising two or more different analytes bound to a solid phase are described, as well as methods for using the same in competitive immunoassays, to determine the presence and amount of one or more analytes of interest in a hair wash sample.

### BACKGROUND

Immunoassays such as radioimmunoassays (RIA) and enzyme immunoassays (EIA) are useful methods for determining the presence, identity, and amount of one or more analytes of interest in a sample. Many immunoassays immobilize an antibody specific for an analyte of interest on a solid phase, e.g., a microplate or bead; binding between the bound antibody and analyte present in a sample is detected, such as through the use of a sandwich assay. Other immunoassays immobilize the analyte; these immunoassays can be referred to as solid phase antigen or solid phase analyte immunoassays. In solid phase analyte immunoassays, the solid phase analyte competes with analyte present in a sample for binding to an antibody specific for the analyte. Typically in such solid phase analyte assays, the antibody is detectable in some manner, e.g., it is labeled, such as radioactively, fluorescently, luminescently, or enzymatically (e.g., an enzymatic reaction occurs in the presence of an appropriate substrate, resulting in a color change) labeled, or its presence is detected via a secondary antibody that itself is labeled.

### SUMMARY

Immunoassays are powerful tools for detecting the presence and/or amount of analytes in, or suspected to be in, a sample. Generally, however, it is necessary to destroy the sample itself to conduct the test. For example, testing of a hair sample can require digestion of the hair using proteases or reducing agents to release the analytes of interest from the hair. The present method, however, is able to use a wash solution prepared by simply washing the hair sample and analyzing the collected wash solution. In some embodiments, the hair sample is left intact following washing. In addition to detecting the presence or absence of an analyte, in some embodiments, the methods provided herein can quantitatively determine the amount of an analyte present in the hair wash sample.

Accordingly, provided herein is a method for determining the presence or absence of an analyte of interest in a hair wash sample comprising:

providing a hair wash sample; and

determining if the analyte of interest is present in the sample using an immunoassay specific for the analyte of interest, wherein the immunoassay is not a radioimmunoassay.

In some embodiments, the method further comprises determining the amount of analyte present, if the analyte is present. For example, the amount of analyte present can be determined quantitatively.

In some embodiments, the immunoassay specific for the analyte of interest comprises using an antibody specific for the analyte. For example, the antibody can be detectably labeled with one or more of a fluorescent, luminescent, or enzymatic label.

Further provided herein is a method for quantitating the amount of an analyte of interest in a hair wash sample comprising:

providing a hair wash sample; and

quantitating the amount of the analyte of interest present in the sample using an immunoassay specific for the analyte of interest, wherein the immunoassay is not a radioimmunoassay.

In some embodiments, a method for determining the presence of one or more analytes of interest in a hair wash sample, wherein at least one of the analytes is a drug of abuse or a metabolite thereof is provided, wherein the method comprises:

providing a hair wash sample; and

determining if one or more of the analytes of interest are present in the sample using an immunoassay specific for the one or more analytes of interest, wherein the immunoassay is not a radioimmunoassay.

For example, a method for quantitating the amount of an analyte of interest in a hair wash sample is also provided, wherein the analyte of interest is a drug of abuse or a metabolite thereof, comprising:

providing a hair wash sample; and

quantitating the amount of the analyte of interest present in the sample using an immunoassay specific for the analyte of interest, wherein the immunoassay is not a radioimmunoassay.

In some embodiments, a method for determining the presence of one or more analytes of interest in a hair wash sample, wherein at least one of the analytes is a prescription or over-the-counter medication or a metabolite thereof is provided, the method comprising:

providing a hair wash sample; and

determining if one or more of the analytes of interest are present in the sample using an immunoassay specific for the one or more analytes of interest, wherein the immunoassay is not a radioimmunoassay.

For example, a method for quantitating the amount of an analyte of interest in a hair wash sample, wherein the analyte of interest is a prescription or over-the-counter medication or a metabolite thereof, comprising:

providing a hair wash sample; and

quantitating the amount of the analyte of interest present in the sample using an immunoassay specific for the analyte of interest, wherein the immunoassay is not a radioimmunoassay.

Provided herein is a method for determining the presence of an analyte of interest in a hair wash sample comprising:

contacting a solid phase analyte composition, wherein the solid phase analyte composition comprises at least one analyte associated with a solid phase support, wherein one of the at least one analytes is the analyte of interest, with:
an antibody, wherein the antibody is specific for the analyte of interest; and
a hair wash sample; and

determining if the analyte of interest is present in the hair wash sample.

In some embodiments, the solid phase analyte composition is first contacted with the antibody, and then with the sample.

In some embodiments, the antibody is detectably labeled. For example, the antibody is detectably labeled with a fluorescent, luminescent, or enzymatic label. In some embodiments, the antibody is not labeled.

In some embodiments, the method further comprises removing antibody that is not bound to the solid phase analyte composition.

In some embodiments, the method further comprises determining the amount of analyte present, if the analyte is present.

In some embodiments, the analyte is determined to be present in the sample by comparing a signal generated by the antibody bound to the solid phase analyte composition in the sample with a signal generated by the antibody bound to the solid phase analyte composition in a control sample that does not comprise the analyte of interest. In some cases, the signal generated by the antibody bound to the solid phase analyte composition is derived from a detectable label on the antibody. In some cases, the signal generated by the antibody bound to the solid phase analyte composition is derived from the binding of a secondary antibody to the antibody, wherein the secondary antibody is detectably labeled. The detectable label can be a fluorescent, luminescent, or enzymatic label.

In some embodiments, the at least one analyte is associated with the solid phase noncovalently, either directly or indirectly. In some embodiments, the at least one analyte is associated with the solid phase covalently, either directly or indirectly. In some embodiments, the at least one analyte is associated with the solid phase via adsorption, either directly or indirectly. In some embodiments, the at least one analyte is covalently linked to a binding agent which is associated with the solid phase noncovalently or via adsorption. For example, the binding agent can be selected from HSA and BSA.

Also provided herein is a method for determining the presence of an analyte of interest in a hair wash sample comprising:

contacting a solid phase analyte composition, wherein the solid phase analyte composition comprises at least two different analytes associated with a solid phase support, wherein one of the at least two different analytes is the analyte of interest, with:
an antibody, wherein the antibody is specific for the analyte of interest; and
a hair wash sample; and
   determining if the analyte of interest is present in the hair wash sample.

In some embodiments, a method for determining the presence of a plurality of different analytes of interest, represented by the number “N”, in a hair wash sample is provided, the method comprising:

contacting a solid phase analyte composition, wherein the solid phase analyte composition comprises at least “N” different analytes associated with a solid phase support, wherein the at least “N” different analytes associated include the plurality of analytes of interest, with:
a plurality of antibodies, wherein the plurality of antibodies comprises an antibody specific for each different analyte of interest; and
a hair wash sample; and
   determining whether each different analyte of interest in the plurality is present in the hair wash sample using an immunoassay, wherein the immunoassay is not a radioimmunoassay.

In some embodiments, the antibodies specific for each different analyte of interest are separately detectable.

Also provided herein is a method for determining the presence of an analyte of interest or one or more metabolites thereof in a hair wash sample comprising:

contacting a solid phase analyte composition, wherein the solid phase analyte composition comprises at least two different analytes associated with a solid phase support, wherein one of the at least two different analytes is the analyte of interest, with:
an antibody, wherein the antibody is specific for the analyte of interest and is further capable of binding to one or more metabolites of the analyte of interest; and
a hair wash sample; and

determining if the analyte of interest or one or more metabolites thereof is present in the hair wash sample using an immunoassay, wherein the immunoassay is not a radioimmunoassay.

In some embodiments, the method includes determining the presence of at least one member of a drug class of interest in a hair wash sample comprising:

contacting a solid phase analyte composition, wherein the solid phase analyte composition comprises at least two different analytes associated with a solid phase support, wherein one of the at least two different analytes is a member of the drug class of interest, with:
an antibody, wherein the antibody is specific for the member of the drug class of interest and is further capable of binding to one or more other members of the drug class of interest or to one or more metabolites of a member of the drug class of interest; and
a hair wash sample; and

determining if at least one member of the drug class of interest is present in the hair wash sample using an immunoassay, wherein the immunoassay is not a radioimmunoassay.

In some embodiments, a method for determining the presence of an analyte of interest in a hair wash sample is provided, the method comprising:

contacting a solid phase composition, wherein the solid phase composition comprises at least one antibody associated with a solid phase support, wherein at least one of the at least one antibodies is specific for the analyte of interest, with:
a second antibody, wherein the second antibody is specific for the analyte of interest; and
a hair wash sample; and

determining if the analyte of interest is present in the hair wash sample.

In some embodiments, the second antibody is detectably labeled. For example, the second antibody can be detectably labeled with a fluorescent, luminescent, or enzymatic label. In some embodiments, the second antibody is not labeled.

In some embodiments, the method further comprises determining the amount of analyte present, if the analyte is present.

In some embodiments, the method further comprises contacting the solid phase composition with a third antibody, wherein the third antibody is detectably labeled. For example, the second antibody can be detectably labeled with a fluorescent, luminescent, or enzymatic label. For example, the third antibody can be specific for the second antibody specific to the analyte of interest.

In some embodiments, the method further comprises removing any second antibody that is not bound to the solid phase composition.

In some embodiments, the at least one antibody is associated with the solid phase noncovalently, either directly or indirectly. In some embodiments, the at least one antibody is associated with the solid phase covalently, either directly or indirectly.

In some embodiments, the at least one antibody is associated with the solid phase via adsorption, either directly or indirectly. In some embodiments, the at least one antibody is covalently linked to a binding agent which is associated with the solid phase noncovalently or via adsorption. For example, the binding agent can be selected from HSA and BSA.

Also provided herein is a method for determining the presence of an analyte of interest in a hair wash sample comprising:

contacting a solid phase composition, wherein the solid phase composition comprises at least two different antibodies associated with a solid phase support, wherein one of the at least two different antibodies is specific for the analyte of interest, with:
a second antibody, wherein the second antibody is specific for the analyte of interest; and
a hair wash sample; and

determining if the analyte of interest is present in the hair wash sample.

In some embodiments, the method includes determining the presence of a plurality of different analytes of interest, represented by the number “N”, in a hair wash sample, the method comprising:

contacting a solid phase composition, wherein the solid phase composition comprises at least “N” different antibodies associated with a solid phase support, wherein the at least “N” different antibodies associated are specific for the plurality of analytes of interest, with:
a second antibody, wherein the second antibody is specific for the analyte of interest; and
a hair wash sample; and

determining whether each different analyte of interest in the plurality is present in the hair wash sample using an immunoassay, wherein the immunoassay is not a radioimmunoassay.

In some embodiments, the antibodies specific for each different analyte of interest are separately detectable.

In some embodiments, a method for determining the presence of an analyte of interest or one or more metabolites thereof in a hair wash sample is provided, the method comprising:
contacting a solid phase composition, wherein the solid phase composition comprises at least two different antibodies associated with a solid phase support, wherein one of the at least two different antibodies is specific for the analyte of interest, with:
a second antibody, wherein the second antibody is specific for the analyte of interest; and
a hair wash sample; and

determining if the analyte of interest or one or more metabolites thereof is present in the hair wash sample using an immunoassay, wherein the immunoassay is not a radioimmunoassay.

For example, a method for determining the presence of at least one member of a drug class of interest in a hair wash sample comprising:

contacting a solid phase composition, wherein the solid phase composition comprises at least one antibody associated with a solid phase support, wherein one of the at least one antibodies is specific for a member of the drug class of interest, with:
a second antibody, wherein the second antibody is specific for the analyte of interest; and
a hair wash sample; and

determining if at least one member of the drug class of interest is present in the hair wash sample using an immunoassay, wherein the immunoassay is not a radioimmunoassay.

In methods described herein, the analyte of interest can be a drug of abuse or metabolite thereof. For example, the drug of abuse or metabolite thereof can be selected from cocaine, benzoylecgonine, cocaethylene, norcocaine, PCP, amphetamine, methamphetamine, cannabinoids, THC, carboxy-THC, heroin, codeine, morphine, 6-monoacetylmorphine (MAM), oxycodone, 3,4-methylenedioxyamphetamine (MDA), 3,4-methylenedioxymethamphetamine (MDMA), ketamine, methadone, khat, bath salts, mescaline, and LSD.

In some embodiments, the analyte of interest is a prescription or over-the-counter medication or a metabolite thereof. For example, the prescription or over-the-counter medication or a metabolite thereof can be selected from the group consisting of: opioids, steroids, amphetamines, cannabinoids, benzodiazepines, NSAIDS, barbiturates, tricyclics, and ephedrines.

In some embodiments, the hair wash sample is derived from the sixth wash of a hair sample.

In some embodiments, a sample is derived from a keratinized structure. In some embodiments, the keratinized structure is hair. In some embodiments, the sample is derived from a hair sample by washing the hair sample, e.g., a hair wash sample. In some embodiments, the hair is washed repeatedly, e.g., two, three, four, five, six, seven, eight, or more times. A hair wash sample can be prepared by any suitable method as is known by those of skill in the art, including without limitation using a method as described in, e.g., Baumgartner and Hill, Sample Preparation Techniques, Forensic Science Int. 63 (1993) 121-135. A hair sample can be washed in any appropriate buffer, including, for example, about 0.005M to about 0.2 M phosphate buffer (e.g., about 0.075M, 0.01M, 0.02M, 0.03M, 0.04M, 0.05M, 0.06M, 0.07M, 0.08M, 0.09M, 0.1M, 0.15M, 0.175M) at a pH of from about 4.5 to about 10.5 (e.g., about 4.5 to about 6.5, about 5.5 to about 6.5; about 5.7 to about 6.2; about 5.9 to about 6.1; about 5.8 to about 7.5; about 5.8 to about 8; about 6 to about 9; about 5.5 to about 9.5; about 5.8, about 6.0, about 6.1, about 6.2, about 6.3, about 6.4, about 6.5, about 6.6, about 6.7, about 6.8, about 6.9, or about 7.0 pH). In some embodiments, the hair is washed in about 0.01M phosphate buffer about pH 6.0. The hair can be washed in the suitable buffer at a temperature of about 25 to about 45° C., e.g., about 25 to about 32; about 28 to about 32; about 30 to about 40; about 25 to about 35° C. The hair wash sample for use in the methods described herein can be derived from the first, second, third, fourth, fifth, sixth, seventh, eighth, or greater wash of a hair sample using such techniques. In some embodiments, the hair wash sample is derived from a sixth wash of a hair sample.

Further provided herein is a kit for quantitatively determining the amount of an analyte of interest in a hair wash sample comprising:

a vial comprising a hair wash solution; and

a solid phase composition comprising:
an analyte of interest associated with a solid phase support, or
an antibody specific for an analyte of interest associated with a solid phase support.

In some embodiments of the kits, the composition comprises at least two different analytes selected from drugs of abuse, toxic chemicals, environmental chemicals, petroleum products, natural products, organic compounds, nutrients, prescription and over-the-counter medications, or metabolites, derivatives, or breakdown products of any of the foregoing.

In some embodiments of the kits, the composition comprises at least two different analytes selected from opioids, amphetamines, NSAIDS, steroids, cannabinoids, benzodiazepines, barbiturates, tricyclics, and ephedrines, or metabolites, derivatives, or breakdown products of any of the foregoing.

Unless otherwise defined, all technical and scientific terms used herein have the same meaning as commonly understood by one of ordinary skill in the art to which this disclosure pertains. Although methods and materials similar or equivalent to those described herein can be used in the practice or testing of the presently described methods, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages will be apparent from the following detailed description, and from the claims.

### DETAILED DESCRIPTION

Provided herein are materials and methods for the rapid, sensitive, and cost-effective detection of one or more different analytes in a hair wash sample. In some embodiments, the hair wash sample is analyzed using an immunoassay specific for one or more of the analytes of interest. For example, the immunoassay can be a non-radioimmunoassay such as an enzyme immunoassay. Any suitable solid phase composition can be used, for example, a solid phase composition comprising (i) one or more analytes of interest associated with the solid phase or (ii) one or more antibodies specific for one or more of the analytes of interest associated with the solid phase. The amount of the analyte of interest, when present, can be determined qualitatively and/or quantitatively. In some embodiments, the assay method is quantitative. The methods described herein surprisingly allow for the detection of low levels of analytes present in a hair wash sample, including samples that have been washed multiple times, e.g., 2, 3, 4, 5, 6 or more times.

In some embodiments, the hair wash sample is analyzed using a solid phase analyte composition having one or more analytes (e.g., at least two different analytes) associated with a solid phase. In some cases, the materials and methods take advantage of the surprising efficiencies and sensitivities generated by binding two or more different analytes to a single solid phase component. The method provided herein surprisingly allow the detection of low levels of analytes present in a hair wash sample, including samples that have been washed multiple times, e.g., 2, 3, 4, 5, 6 or more times. For example, a microplate wherein each microwell has the same two or more different analytes bound thereto can be used to determine the presence and/or amount of two or more different analytes in a sample in a single microwell by using a differentially labeled antibody for each of the two or more analytes of interest in a competitive immunoassay; by probing for the differential signal of each specific antibody, the presence and/or amount of the analyte for which it is specific can be determined.

In other embodiments, the solid phase compositions provided herein can be used to determine the presence and/or amount of two or more different analytes by separately detecting the two or more different analytes using separate (but having the same set of two or more analytes bound) solid phase analyte compositions and the appropriate labeled antibody specific for the analyte of interest (e.g., a tandem or side-by-side assay). In yet other embodiments, the same solid phase composition can be used to determine the presence and/or amount of two or more different analytes by first using the solid phase analyte composition to determine the presence and/or amount of at least a first analyte using an antibody specific for the at least first analyte, and then using the same solid phase composition to determine the presence and/or amount of the at least second analyte using an antibody specific for the at least second analyte, e.g., either immediately or after removal of any interfering substances from the first assay. Such assay formats can be referred to as serial assays. See, for example, WO 2009/134855.

As used herein, the phrases “determine the presence” and “determining the presence” mean determining whether or not an analyte is present. Thus, if an analyte is determined to be absent, such an activity would still be encompassed by the phrases.

An analyte can be any chemical, including drugs of abuse, toxic chemicals, environmental chemicals (e.g., pesticides, herbicides, insecticides), petroleum products, natural products, organic compounds, nutrients, prescription or over-the-counter medications (e.g., pain medications, steroids, narcotics, NSAIDS), or metabolites, derivatives, or breakdown products of any of the foregoing.

In some embodiments, analytes of interest are drugs, such as drugs of abuse, prescription medications, or pain medications. Particular drug classes of interest include opioids, steroids, amphetamines, cannabinoids, benzodiazepines, NSAIDS, barbiturates, tricyclics, and ephedrines.

In some embodiments, an analyte of interest can be selected from: cocaine (and metabolites benzoylecgonine, cocaethylene, and norcocaine), opioids and metabolites thereof (morphine, heroin, 6-monoacetylmorphine, diacetylmorphine, codeine, oxycodone, hydrocodone, hydromorphone, oxymorphone, and methadone), phencyclidine (PCP), amphetamines, methamphetamines, MDMA (ecstasy, methylenedioxy-methamphetamine), MDA (methylenedioxyamphetamine), cannabinoids (and THC and carboxy-THC metabolites), propoxyphene, meperidine, benzodiazepines (alprazolam, chlordiazepoxide, diazepam, lorazepam, flunitrazepam, triazolom, and estazolam), barbiturates (mephobarbital, pentobarbital), carisoprodol, tramadol, fentanyl, buprenorphine, naltrexone, tricyclics, nicotine (and its metabolite cotinine), eve (methylenedioxy-ethylamphetamine), lysergic acid (LSD), digoxin, methylphenidate, acetaminophen, salicylates, fluoxetine, sertraline, dextromethorphan, ephedrine, phenethylamines, pseudoephedrine, synephrine, ketamine, methadone, khat, bath salts, and mescaline.

In some embodiments, an analyte of interest is a drug of abuse or metabolite thereof, and can be selected from the following: cocaine, benzoylecgonine, cocaethylene, norcocaine, PCP, amphetamine, methamphetamine, cannabinoids, THC, carboxy-THC, heroin, codeine, morphine, 6-monoacetylmorphine (MAM), oxycodone, 3,4-methylenedioxyamphetamine (MDA), 3,4-methylenedioxymethamphetamine (MDMA), ketamine, methadone, khat, bath salts, mescaline, and LSD.

In some embodiments, the sample is derived from a hair sample by washing the hair sample, e.g., a hair wash sample. In some embodiments, the hair is washed repeatedly, e.g., two, three, four, five, six, seven, eight, or more times. A hair wash sample can be prepared by any suitable method as is known by those of skill in the art, including without limitation using a method as described in, e.g., Baumgartner and Hill, Sample Preparation Techniques, Forensic Science Int. 63 (1993) 121-135. A hair sample can be washed in any appropriate buffer, including, for example, about 0.005M to about 0.2 M phosphate buffer (e.g., about 0.075M, 0.01M, 0.02M, 0.03M, 0.04M, 0.05M, 0.06M, 0.07M, 0.08M, 0.09M, 0.1M, 0.15M, 0.175M) at a pH of from about 4.5 to about 10.5 (e.g., about 4.5 to about 6.5, about 5.5 to about 6.5; about 5.7 to about 6.2; about 5.9 to about 6.1; about 5.8 to about 7.5; about 5.8 to about 8; about 6 to about 9; about 5.5 to about 9.5; about 5.8, about 6.0, about 6.1, about 6.2, about 6.3, about 6.4, about 6.5, about 6.6, about 6.7, about 6.8, about 6.9, or about 7.0 pH). In some embodiments, the hair is washed in about 0.01M phosphate buffer about pH 6.0. The hair can be washed in the suitable buffer at a temperature of about 25 to about 45° C., e.g., about 25 to about 32; about 28 to about 32; about 30 to about 40; about 25 to about 35° C. The hair wash sample for use in the methods described herein can be derived from the first, second, third, fourth, fifth, sixth, seventh, eighth, or greater wash of a hair sample using such techniques. In some embodiments, the hair wash sample is derived from a sixth wash of a hair sample.

### Applications

The technology described herein relates to determining the presence and/or amount of one or more analytes of interest, such as in a hair wash sample.

A hair wash sample can be analyzed using an immunoassay such as an enzyme immunoassay (EIA). In some embodiments, the immunoassay is not a radioimmunoassay. Hair wash samples have been previously measured using a radioimmunoassays, but it was surprisingly found that other types of immunoassays, such as enzyme immunoassays, can be used to detect and/or quantify the presence of an analyte of interest in a hair wash sample. Without being bound by any theory, it was previously thought that hair wash samples could not be measured, let alone quantified, using other immunoassay detection methods. This was due in part to the sample dilution necessary when going from a radioimmunoassay to other types of immunoassays (e.g., enzyme immunoassays). The relatively low concentrations of analyte present in a hair wash sample as compared to the hair itself, coupled with the low concentrations of sample used in a non-radioimmunoassay, led to a belief that any error introduced by using a hair wash sample would be propagated in the subsequent sample dilution and lead to erroneous and unreliable results. Contrary to this belief, the inventors have discovered a method for analyzing hair washes using a non-radioimmunoassay to detect and/or quantify the presence of analytes of interest.

In particular embodiments, instrumental methods may be used to confirm positive results obtained in the immunoassay methods described herein. For example, instrumental analysis methods such as gas chromatography, liquid chromatography and mass spectrometry can be used. In some embodiments, the immunoassay is quantitative, thus eliminating the need for additional detection and/or quantification methods saving both time and money.

In some embodiments, the methods involve sandwich immunoassays, which are methods well-known to those having ordinary skill in the art. In the sandwich immunoassays provided herein, one or more antibodies specific for one or more analytes of interest are bound to a solid phase. Upon exposure to a sample containing one or more of the analytes of interest, the analytes bind to the corresponding antibody bound to the solid phase. In some embodiments, the solid phase composition is contacted with a second antibody specific for the analyte of interest. The signal generated by this second antibody can be compared to that generated in control samples or prior to application of the test sample, allowing for determination of the presence of an analyte.

In such methods, a solid-phase support can be prepared by associating a solid phase, such as a particle or multiwell of a multiwell plate, with one or more antibodies specific for one or more analytes of interest (e.g., at least two antibodies). The solid phase support can then be contacted with one or more second antibodies, wherein at least one of the second antibodies is specific for one of the analytes of interest, and also contacted with a sample (e.g., a hair wash sample), which can contain or can be suspected to contain one or more analytes of interest. Typically, the second antibody is detectably labeled (e.g., fluorescently, luminescently (e.g., bioluminescently or chemiluminescently), or enzymatically), or can be detected via the use of a secondary antibody that binds to the second antibody using methods (e.g., enzymatic amplification methods) known to those having ordinary skill in the art. In such methods, interaction of the second antibody with the analyte for which it is specific results in the generation of a detectable signal, e.g., via the detectable label on the antibody or via a label on the secondary antibody. The signal is measured as a read-out of the presence or amount of the analyte. In some embodiments, a chemiluminescent enzyme immunoassay is employed.

In some embodiments, the methods involve competitive immunoassays, which are methods well-known to those having ordinary skill in the art. In the competitive immunoassays employed herein, an analyte bound to a solid phase competes with an analyte present in a sample solution (e.g., a test sample) for binding to an antibody, such as a labeled antibody. The signal generated by the antibody after application of the sample to the solid phase composition can be compared to that generated after application of a control sample, or prior to application of the test sample, allowing for determination of the presence of an analyte. In some embodiments, the present compositions and methods allow for the simultaneous or serial detection of two or more analytes, if desired, with high sensitivity and minimal interference from the other analytes.

In these methods, a solid-phase analyte support can be prepared by associating a solid phase, such as a particle or multiwell of a multiwell plate, with one or more analytes (e.g., at least two analytes). The solid phase analyte support is then contacted with one or more antibodies, wherein at least one antibody is specific for one of the analytes associated with the solid composition, and also contacted with a sample (e.g., a hair wash sample), which can contain or can be suspected to contain one or more analytes of interest. Typically, the antibody is detectably labeled (e.g., fluorescently, luminescently (e.g., bioluminescently or chemiluminescently), or enzymatically), or can be detected via the use of a secondary antibody that binds to the first antibody using methods (e.g., enzymatic amplification methods) known to those having ordinary skill in the art. In such methods, interaction of the antibody with the analyte for which it is specific results in the generation of a detectable signal, e.g., via the detectable label on the antibody or via a label on the secondary antibody. The signal is measured as a read-out of the presence or amount of the analyte. In some embodiments, a chemiluminescent enzyme immunoassay is employed.

An antibody for use in the methods can be any antibody that is specific for an analyte of interest. The term includes an antibody or analyte-binding fragment thereof. The term also encompasses a humanized antibody, a fully human antibody, a single chain antibody, a chimeric antibody, an F_{ab} fragment, an F_{(ab′)2} fragment, an F_{ab′} fragment, an Fᵥ fragment, and an scFᵥ fragment. Antibodies to an analyte of interest can be obtained commercially from a number of sources or can be prepared and isolated using methods known to those having ordinary skill in the art, e.g., isolating the antibody from a host animal (e.g., a mammal such as a rat, rabbit, mouse, goat, cow, horse, dog, cat, sheep, donkey, chicken or a human) or cell (e.g., a hybridoma) that produces the antibody.

In some embodiments, the antibody is specific for the analyte of interest and is further capable of binding to one or more metabolites of the analyte of interest. For example, an antibody can be specific for cocaine, yet can demonstrate cross-reactive binding with one or more of cocaine's metabolites. In such cases, the cross-reactive binding should be sufficient to detect the one or more metabolites using the methods described herein.

Similarly, an antibody may be specific for a member of a drug class of interest and may be further capable of binding to one or more members of the drug class of interest and/or their metabolites. For example, an antibody may be specific for a particular opioid, yet can demonstrate cross-reactive binding to other opioids. In such cases, the cross-reactive binding should be sufficient to detect the one or more drugs or drug metabolites within the drug class using the methods described herein.

A method to determine the presence and/or amount of one or more analytes can be carried out as follows. A solid phase analyte composition, as described above, such as a microplate comprising a microwell having at least two different analytes associated with each microwell, can be contacted with i) at least one antibody, wherein the at least one antibody is specific for an analyte of interest; and ii) a sample, as described previously, e.g., a hair wash sample.

In the methods described above, contacting can include any method of contacting, e.g., manually pipetting, washing, robotic or automated dispensing mechanisms, or other methods known to those having ordinary skill in the art. Routine care in the methods of contacting, e.g., sterile techniques or other methods to preserve sample integrity are understood by those having ordinary skill in the art.

The solid phase analyte composition may be first contacted with the antibody, and then with the sample, or vice versa. Depending on the method employed, a known amount of an antibody or a secondary antibody may be contacted with the solid phase composition, e.g., in quantitative methods.

Typically, an antibody that is detectably labeled is used in the methods described herein and the label enables the determination of the presence of the analyte. For example, the antibody can be detectably labeled with a fluorescent, luminescent (including chemiluminescent or bioluminescent), radioactive, or enzymatic label. In some cases, the antibody is not labeled, but is detected via the use of a secondary antibody that itself is labeled (e.g., enzymatically labeled) and that is specific for the first antibody. In some cases, a labeled second antibody specific for the analyte of interest is used. In cases where multiple analytes are detected simultaneously, the separate antibodies specific to each analyte of interest are preferably differentially labeled so that each can be detected separately from the others, e.g., through the use of fluorescent labels having non-overlapping absorption/emission spectra. Methods for detection, including automated methods, are well known to those having ordinary skill in the art.

Any of the methods can employ the use of a wash step, e.g., to remove antibody and analytes not bound to the solid phase analyte composition. Suitable wash conditions can be determined by those having ordinary skill in the art and should not substantially interfere, or only minimally interfere, with the binding of the antibody to the associated analyte on the solid phase.

In some embodiments, the analyte can be determined to be present in the sample by taking advantage of the competitive nature of the assay. For example, the analyte can be determined to be present by comparing a signal generated by the antibody (e.g., from a fluorescent label on the antibody) bound to the solid phase analyte composition after contacting with the sample (e.g., the test sample) with a signal generated by the antibody bound to the solid phase analyte composition after contacting with a control sample that does not comprise the analyte of interest.

In some embodiments, the solid phase analyte composition can be contacted with a second antibody, where the second antibody is specific for a second different analyte associated with the solid phase. The second antibody can be contacted at the same time as the first antibody (e.g., in a simultaneous assay for two analytes), or serially (e.g., in assays wherein it is desired to determine the presence of a first analyte prior to determination of a second analyte). As one having ordinary skill in the art will recognize, conceivably up to N antibodies, corresponding to the number of analytes associated with the solid phase or expected in the sample, can be employed in the method, where the antibody population includes at least one antibody specific for each analyte. Moreover, while up to N analytes can be detected in a simultaneous assay, any smaller number can be detected in any assay, or any combination can be detected, e.g., in a simultaneous or serial assay. Similarly, up to N antibodies, specific for the number (N) analytes of interest, can be associated with the solid phase and employed in a method provided herein, where the antibody population includes at least one antibody specific for each analyte. As above, while up to N analytes can be detected in a simultaneous assay, any smaller number can be detected in any assay, or any combination can be detected, e.g., in a simultaneous or serial assay.

In addition, in certain embodiments, such as those employing microwell plates, one microwell may be used to test for one or more analytes of interest, while another microwell may be used to test for the same set of analytes of interest, a different set of analytes of interest, or an overlapping but not identical set of analytes of interest.

The method can be used to detect the use and prior use of any analyte of interest described previously, including drugs of abuse such as cocaine, morphine/heroin and other opioids, cannabinoids, marijuana, phencyclidine or “PCP,” methaqualone, and amphetamines. Moreover, the method can be effective in determining prior usage of prescription drugs such as digoxin, methadone and benzodiazepines. It is contemplated that any analyte, particularly any organic analyte, present in the bloodstream of an individual which is transferred to the hair during its synthesis can be extracted and analyzed in accordance with the methods described herein.

In certain embodiments a detergent can be used to aid in the release of one or more analytes of interest. Certain biological detergent compounds useful for solubilizing biological membrane components aid in the release of the analytes at a relatively low pH while not interfering with subsequent analyte detection. These biological detergents can aid the in the treatment of a hair sample at a pH in the range of about 5 to about 10.5. Suitable detergents include bile acid detergents, such as glycocholic acid, cholic acid, taurocholic acid, deoxycholic acid, glycodeoxycholic acid, taurodeoxycholic acid and salts thereof, including sodium salts. Other detergents for use in the methods are sulfo-betaines, such as the Zwittergents® and betaines, such as Empigen BB (N-dodecyl-N,N-dimethylglycine) (all available from Calbiochem Corp., La Jolla, Calif.). Other detergents include alkylglucosides, including hexyl-beta-D-glucopyranoside, heptyl-beta-D-glucopyranoside, octyl-beta-D-glucopyranoside, nonyl-beta-D-glucopyranoside, decyl-beta-D-glucopyranoside, dodecyl-beta-D-maltoside and octyl-beta-D-thioglucopyranoside (OSGP). Mixtures of alkylglucosides, such as the product ELUGENT® (Calbiochem), are also effective.

Particularly preferred are the bile acids cholic acid and glycocholic acid, can be used during a wash of a hair sample at a pH in the range of about 6.3 to about 8. In some embodiments, deoxycholates such as deoxycholic acid and glycodeoxycholic acid can be used at a pH above about 7.

The detergents can be used in the industry standard five-drug screen for the most common drugs of abuse in the United States, i.e., marijuana, cocaine, phencyclidine, methamphetamine and opioids, measured using the methods described herein. Thus, they do not impact any of the analytes or antibodies involved in the five-drug screen, and do not result in false negatives or positives. The particular detergents most effective for use in the five-drug screen are cholate, deoxycholate, cholic acid, deoxycholic acid, octyl-beta-D-glucopyranoside and octyl-beta-D-thioglucopyranoside. The bile acid detergents, alkylglucosides, sulfobetaines and betaines are preferred when a screen is performed that includes cocaine, opioids, phencyclidine, amphetamines and sympathomimetic amines. In a screen solely for cocaine, the preferred detergents are cholic acid, Zwittergents®, alkylglucoides, and N-dodecyl-N,N dimethylglycine.

The benefits to be obtained from the presently disclosed methods are many, including a prompt, accurate, and inexpensive determination of prior exposure to a particular analyte. The method can provide a record of consumption, or non-consumption, over very long periods of time. By removal of any proteolytic or reducing treatment steps, both the expense of these methods, the destruction of the sample, and certain interferences with biological analyte detection agents are reduced or eliminated. Moreover, hair collection is less intrusive and less physically repulsive than blood or urine collection, and samples cannot be altered or substituted, nor can detection be evaded by short term abstention or “flushing” (excessive fluid intake) prior to a scheduled testing, e.g., pre-employment test or annual physical examination. Samples may be stored indefinitely without refrigeration. Finally, the methods facilitate both screening and confirmatory assays for detecting an analyte of interest.

### Compositions

Provided herein are compositions useful for detecting (e.g., determining the presence and/or amount of) one or more different analytes of interest in a sample. In some embodiments, the compositions include a solid phase support associated with one or more analytes (e.g., at least two analytes), e.g., 1, 2, 3, 4, 5, 6, 7, 8, 9, 10, 11, 12, 13, 14, 15, 16, 17, 18, 19, or 20 analytes, or more. In some embodiments, from 2 to 5 analytes are associated with the solid phase support. In other embodiments, 5 to 10 analytes are associated with the solid phase support. Such compositions are referred to as solid phase analyte compositions herein.

Also provided herein compositions including a solid phase support associated with one or more antibodies specific for one or more analytes of interest, e.g., 1, 2, 3, 4, 5, 6, 7, 8, 9, 10, 11, 12, 13, 14, 15, 16, 17, 18, 19, or 20 antibodies, or more. In some embodiments, from 2 to 5 antibodies are associated with the solid phase support. In other embodiments, 5 to 10 antibodies are associated with the solid phase support. Such compositions are referred to as solid phase antibody compositions herein.

As will be evident to those having ordinary skill in the art, although the compositions make it possible to determine the presence and/or amount of the total number of different analytes (“N”), one need not determine (or evaluate) the presence and/or amount of all analytes that are possible to be determined with a given solid phase composition. For example, in some embodiments, it may be useful to determine the presence and/or amount of only one analyte of interest. In other embodiments, it may be useful to first determine if one or more analytes of interest is/are present, followed by determining if a second or more analytes is/are present. The solid phase compositions described herein facilitate the simultaneous, tandem, or serial detection of up to the number of analytes “N” associated with the solid phase.

In particular embodiments, a composition can include at least two of: cocaine, one or more opioids, PCP, amphetamines, and cannabinoids associated with the solid support. In particular embodiments two or more of pain management medications selected from morphine, codeine, oxycodone, oxymorphone, hydrocodone, or hydromorphone can be associated with the solid support. In some embodiments, two or more of cocaine and an opioid can be associated with the solid support.

In some embodiments, a composition can include at least two of: cocaine, one or more opioids, PCP, amphetamines, and cannabinoids specific antibodies associated with the solid support. In particular embodiments two or more of pain management medications selected from morphine, codeine, oxycodone, oxymorphone, hydrocodone, or hydromorphone specific antibodies can be associated with the solid support. In some embodiments, two or more of cocaine and an opioid specific antibodies can be associated with the solid support.

Any type of sample can be tested for the presence and/or amount of one or more analytes of interest. In certain cases, a sample contains or is suspected to contain one or more analytes of interest, such as one or more drugs of abuse or toxic chemicals. A sample can be a bodily sample or a non-bodily sample. A bodily sample (e.g., a hair sample) can be a specimen obtained from an individual (e.g., a human, mouse, rat, pig, horse, monkey, rabbit, cow, sheep, or goat). A bodily sample can be a tissue sample, such as a tissue sample of the brain, heart, lungs, kidneys, liver, muscle, bone, stomach, intestines, or skin. A bodily sample can be obtained by biopsy or from tissue culture. A bodily sample can include a biological fluid such as urine, blood, plasma, serum, saliva, semen, sputum, cerebral spinal fluid, mucus, sweat, milk, vitreous fluid and the like. A bodily sample can be a keratinized structure, such as hair, a fingernail, or a toenail. A non-bodily sample can be, for example, a soil or water sample, a plant sample, an inorganic material sample, or a sample from a research or manufacturing process.

A sample can be used as is, or can be treated to result in a final sample for detection of the one or more analytes. For example, a sample can be liquefied, concentrated, dried, diluted, lyophilized, extracted, fractionated, subjected to chromatography, purified, acidified, reduced, degraded, subjected to enzymatic treatment, or otherwise treated in ways known to those having ordinary skill in the art in order to release an analyte of interest. If desired, a sample can be a combination (pool) of samples, e.g., from an individual or from a manufacturing process.

A sample can be in a variety of physical states, e.g., liquid, solid, emulsion, or gel. Samples can be treated with customary care to preserve analyte integrity. Treatment can include the use of appropriate buffers and/or inhibitors, such as inhibitors of certain biological enzymes. One having ordinary skill in the art will be able to determine the appropriate conditions given the analytes of interest and the nature of the sample.

In some embodiments, a sample is derived from a bodily sample.

In some embodiments, a sample is derived from a keratinized structure. In some embodiments, the keratinized structure is hair.

As used herein, the terms “solid phase” and “solid phase support” are used interchangeably, and refer to any solid or semi-solid material with which two or more analytes can be associated, e.g., a material to which they can be attached covalently or noncovalently, either directly or indirectly, or a material in which they can be incorporated (e.g., physical entrapment, adsorption, etc.), or a material which can be functionalized to include (e.g., to associate with) the one or more analytes or one or more antibodies. In addition to the analytes or antibodies, a solid phase support can contain a variety of materials including, e.g., a natural or synthetic polymer, resin, metal, or silicate.

Suitable solid phase supports are known in the art and illustratively include agaroses (commercially available as Sepharose); celluloses (e.g., a carboxymethyl cellulose); dextrans, (such as Sephadex); polyacrylamides; polystyrenes; polyethylene glycols; resins; silicates; divinylbenzenes; methacrylates; polymethacrylates; glass; ceramics; papers; metals; metalloids; polyacryloylmorpholidse; polyamides; poly(tetrafluoroethylenes); polyethylenes; polypropylenes; poly(4-methylbutenes); poly(ethylene terephthalates); rayons; nylons; poly(vinyl butyrates); polyvinylidene difluorides (PVDF); silicones; polyformaldehydes; cellulose acetates; nitrocellulosse, or combinations of two or more of any of the foregoing. All that is required is that the material or combination of materials in the solid phase support not substantially interfere, e.g., in some cases only minimally interfere, with the binding between the analytes and the antibodies specific for each analyte.

A solid phase support can have a variety of physical formats, which can include for example, a membrane; a chip; a slide (e.g., a glass slide or coverslip); a column; a hollow, solid, semi-solid, pore or cavity containing particle such as a bead; a gel; a fiber including a fiber optic material; a matrix; and a sample receptacle. Non-limiting examples of sample receptacles include sample wells, tubes, capillaries, vials and any other vessel, groove or indentation capable of holding a sample. A sample receptacle can be contained on a multi-sample platform, such as a microplate, slide, microfluidics device, multiwell or microwell plate, and the like. A particle to which an analyte is associated with can have a variety of sizes, including particles that remain suspended in a solution of desired viscosity, as well as particles that readily precipitate in a solution of desired viscosity. Particles can be selected for ease of separation from sample constituents, for example, by including purification tags for separation with a suitable tag-binding material, paramagnetic properties for magnetic separation, and the like.

Generally, a particle described herein has a spherical shape. However, a particle can be, e.g., oblong or tube-like. In some embodiments, e.g., a crystalline form particle, the particle can have polyhedral shape (irregular or regular), such as a cube shape. In some embodiments, a particle can be amorphous.

In some embodiments, a particle mixture can be substantially spherical, substantially oblong, substantially tube-like, substantially polyhedral, or substantially amorphous. By “substantially” is meant that the particle mixture is more than 30 (e.g., 35, 40, 45, 50, 55, 60, 65, 70, 75, 80, 85, 90, 95, 96, 97, 98, or 99 or more) % of a given shape.

In some embodiments, the diameter (or longest straight dimension) of the particle can be between about 1 nm to about 1000 nm or larger. For example, a particle can be at least about 1 nm to about 1000 nm (e.g., at least about two, three, four, five, six, seven, eight, nine, 10, 15, 20, 25, 30, 35, 40, 45, 50, 75, 100, 150, 200, 250, 300, 325, 350, 375, 400, 425, 450, 475, 500, 525, 550, 575, 600, 625, 650, 675, 700, 725, 750, 775, 800, 825, 850, 875, 900, 925, 950, 975, or 1000 nm). In some embodiments, a particle can be not more than 1000 nm (e.g., not more than 975, 950, 925, 900, 875, 850, 825, 800, 775, 750, 725, 700, 675, 650, 625, 600, 575, 550, 525, 500, 475, 450, 425, 400, 375, 350, 325, 300, 275, 250, 225, 200, 175, 150, 125, 100, 75, 50, 45, 40, 35, 30, 25, 20, 15, 10, or five nm) in diameter (or at its longest straight dimension).

Suitable methods for producing solid-phase supports, as well as additional examples of solid-phase supports (e.g., particles) for use in the compositions and methods described herein, can be found in, e.g., PCT Publication Nos. WO 01/84157, WO 99/30160, WO 99/42838, and WO 06/078618, the disclosures of each of which are incorporated by reference in their entirety.

An analyte or antibody can be associated with a solid phase support in a number of ways known to those having ordinary skill in the art. For example, an analyte or antibody can be covalently or non-covalently bound to a solid-phase support, either directly or indirectly, such as through a linker, binding agent, or member of a binding pair. For example, an analyte or antibody can be directly covalently bound to a solid phase support, e.g., through a chemical bond between a functional group on the analyte and a functional group on the solid phase support. Alternatively, an analyte or antibody can be indirectly covalently bound to a solid-phase support, e.g., an analyte or antibody can be covalently bound to a linker or binding agent, which itself is covalently bound to the solid phase support. In some embodiments, an analyte or antibody is directly non-covalently bound to a solid phase support, e.g., noncovalent association or adsorption of the analyte or antibody on the solid phase support. In other embodiments, an analyte or antibody is indirectly noncovalently bound to a solid phase support, e.g., is covalently bound to a linker, binding agent, or member of a binding pair, which noncovalently associates with the solid phase support. In all cases, association of an analyte of interest or antibody specific for an analyte of interest with a solid phase should not substantially affect, e.g., should only minimally affect, the specificity of an antibody for the associated analyte or the analyte itself as compared to the specificity for the analyte or of the antibody when it is not associated with a solid phase.

A variety of chemical reactions useful for covalently attaching an analyte to a support are well known to those skilled in the art (see, for example, Hartmann et al. (2002) J. Mater. Res. 17(2):473-478). Illustrative examples of functional groups useful for covalent attachment to a support include alkyl, Si—OH, carboxy, carbonyl, hydroxyl, amide, amine, amino, ether, ester, epoxides, cyanate, isocyanate, thiocyanate, sulfhydryl, disulfide, oxide, diazo, iodine, sulfonic or similar groups having chemical or potential chemical reactivity.

An analyte or antibody can be noncovalently bound to a solid support, such as through adsorption to or coating on the solid phase support, or through covalent or noncovalent association with a linker, binding agent, or member of a binding pair, which itself is noncovalently bound or associated with the solid support. Illustrative examples of linkers, binding agents, or members of binding pairs useful for association of analytes or antibody to a support include proteins, organic polymers (PEG and derivatives thereof), and small molecules. Particular preferred examples include HSA, BSA, streptavidin, avidin, biotin, PEG, and antibodies or antibody fragments.

For example, in one preferred embodiment, an analyte can be covalently conjugated to a binding agent such as HSA or BSA, and then the resulting covalent conjugate can be used to noncovalently coat a solid support. In another embodiment, an analyte can be covalently conjugated to one member of a biotin and avidin binding pair; the covalent conjugate can then non-covalently bind to the other member of the binding pair, which can be noncovalently associated with (e.g., coated on) a solid support. In other embodiments, a covalent conjugate of an analyte with one member of a binding pair can bind noncovalently to the other member of the binding pair, which has been covalently linked to the solid support.

Linkers or binding agents can also be useful to covalently link an analyte or antibody to a solid support. For example, a covalent conjugate of an analyte with a binding agent such as HSA or BSA can be covalently linked to the solid support.

In some embodiments, the surface of the solid-phase support can be modified to facilitate the stable attachment of linkers or binding agents. Generally a skilled artisan can use routine methods to modify a solid-phase support in accordance with the desired application. The following are non-limiting examples of solid-phase support modifications.

The surface of the solid-phase support can, e.g., have a coating that facilitates the attachment to the analyte or antibody. In general, the coating will be one that is complementary to a linker moiety on the analyte or antibody or to the antibody itself. The surface of a solid-phase support can be amidated, e.g., by silylating the surface, e.g., with trialkoxyaminosilane. Silane-treated supports can also be derivatized with homobifunctional and heterobifunctional linkers. The support can be derivatized, e.g., so it has a hydroxy, an amino (e.g., alkylamine), carboxyl group, N-hydroxy-succinimidyl ester, photoactivatable group, sulfhydryl, ketone, or other functional group available for reaction. The supports can be derivatized with a mask in order to only derivatize limited areas (e.g., certain wells of a multiwell assay plate) or a chemical etch or UV light can be used to remove derivatization from selected regions.

The functional groups, instead of being coated on the surface, can be incorporated into the first solid-phase support either during or after the preparation of the first solid-phase support. The functional groups are usually chosen to dissolve in one or more components of the first solid-phase support but may be covalently attached to the first solid-phase support.

Additional methods for attaching an analyte to a solid-phase support are described in, e.g., PCT Publication Nos. WO 01/84157, WO 99/30160, and WO 06/078618, the disclosures of each of which are incorporated by reference in their entirety.

In some embodiments, two or more analytes or antibodies are associated with the solid phase support. The type of association of each of the two or more analytes or antibodies with the solid phase support can be the same or different relative to the association of the other analytes or antibodies. For example, one analyte can be directly covalently bound, while another is indirectly covalently bound through a linker moiety. In another embodiment, one analyte can be covalently bound to a binding agent such as BSA, which is noncovalently bound to a solid phase support, while another analyte is directly covalently bound to the solid phase support. All that is required is that the separate associations do not interfere (e.g., do not interfere substantially) with the binding of an analyte with the antibody specific for the analyte.

The solid phase compositions comprising two or more different analytes associated with the solid phase can be surprisingly robust, e.g., can be stable for an extended period of time at room temperature. In some embodiments, the solid phase compositions described herein can be frozen, lyophilized, or immobilized and stored under appropriate conditions. Conditions should be such as to allow the analytes to retain activity.

### Kits

Also provided herein are kits, such as kits that include a hair was solution and one or more solid phase compositions described herein. For example, the solid phase composition can comprise (i) one or more analytes associated with a solid support; or (ii) one or more antibodies associated with a solid support. The kits can include additional components, including buffers, reagents, instructions for use, and one or more antibodies (e.g., antibodies specific for the analytes and secondary antibodies) for use in the methods. In some embodiments, at least one antibody specific for an analyte selected from the group consisting of cocaine, benzoylecgonine, cocaethylene, norcocaine, PCP, amphetamine, methamphetamine, cannabinoids, THC, carboxy-THC, heroin, codeine, morphine, 6-monoacetylmorphine (MAM), oxycodone, 3,4-methylenedioxyamphetamine (MDA), 3,4-methylenedioxymethamphetamine (MDMA), ketamine, methadone, khat, bath salts, mescaline, or LSD is included in a kit. In some embodiments, the kits may include additional reagents for sample preparation, including reagent to extract or treat a sample for use in the methods. In some embodiments, the kit provides for quantitative detection of one or more analytes of interest.

### EXAMPLES

### Example 1

### Reductive Extraction of Analytes from Hair and Detection of Multiple Analytes Using Solid Phase Compositions Having Multiple Analytes Bound Thereto

Hair samples were analyzed for the presence of multiple analytes (e.g., drugs of abuse) using extraction methods as disclosed in U.S. application Ser. No. 12/111,914, incorporated herein by reference, entitled “Non-Proteolytic Method For The Determination Of Analytes In Keratinized Structures,” (disclosing nonproteolytic reductive methods for extracting analytes from hair), filed simultaneously herewith on Apr. 29, 2008. Results obtained using such nonproteolytic reductive methods were also compared with results obtained using methods as disclosed in U.S. Pat. Nos. 6,022,693; 6,350,582; and 6,949,344 (disclosing combined proteolytic and reductive methods for extracting analytes from hair). Once extracted, the test samples were evaluated for the presence of multiple drug of abuse analytes using the methods and compositions disclosed herein, e.g., contacted with a solid phase having bound thereto two or more analytes and with one or more primary antibodies, each specific for a particular analyte; each primary antibody is then detected, e.g., through a label on the primary antibody or through detection of the primary antibody via a labeled secondary antibody.

### I. Solutions

### Solution to Digest a Hair Sample:

1.5% solution of Dithiothreitol in water, pH 9.45-9.55

### Solution to Neutralize a Digested Hair Sample:

1. 5% Zinc Chloride in water.

### 2. 1.0 M Bis Tris pH 7

3. Immediately prior to use, dilute the Zinc Chloride 1:10 in the Bis-Tris.

### II. Treatment Procedure for Analyte Extraction for Enzyme Immunoassay (EIA)

8 mg of hair samples was placed in test tubes with 0.8 mL of 1.5% Dithiothreitol solution, pH 9.5, and the samples incubated at 37° C. for 2 hours. Samples were neutralized with 70 μL of Zinc Chloride in Bis-Tris, mixed well and centrifuged.

### III. Enzyme Immunoassay (EIA) Using Multi Analyte Coated Microplates and Using Dithiothreitol Extracts of Hair: Cocaine, Opioids, Amphetamines, PCP

A. Preparation of Microplates: Coating with BSA-Analyte Conjugates

BSA (Bovine serum albumin) conjugates of the drugs of interest purchased from East Coast Biologicals were prepared in water. BSA conjugates (BSA-benzoylecgonine, BSA-morphine, BSA-PCP, BSA-methamphetamine) were dissolved in water such that from 1-10 ng of each of the analytes was present in 50 μL of drug conjugate solution.

To coat the wells, fifty μL per well of the drug conjugate solution containing BSA-conjugates of benzoylecgonine, morphine, PCP, and methamphetamine were added to the wells on a 96-well microplate (high binding microplate from Corning Scientific). The plate was covered and placed on a rotator overnight at room temperature (RT) with rotation at about 100 cycles/min.

After overnight rotation, the analyte mixture was removed and the wells washed once with PBS (phosphate buffered saline). To block the wells, 300 μL PBS containing 1% BSA were added to all wells, and the microplates rotated at RT for 4-6 hours (rotation speed about 100 cycles/min)

After blocking, the wells were washed 6 times with PBS containing 0.01% Tween-20. After washing, the plates were inverted and rapped against the counter to remove any liquid. The plates were then left inverted to dry on the bench for a few hours or overnight. When dry, they were placed in desiccated sealable vacuum bags; the air was withdrawn from the bag with a vacuum pump and the bag was sealed for storage.

B. Analysis

Aliquots of the digested and neutralized hair samples were combined in the microplate wells with an appropriate primary antibody directed against the analyte(s) of interest. After a 1-hour incubation at RT, the plates were washed with PBS on an automated plate washer. Following the wash, secondary antibody (directed against the primary antibody species) linked to HRP (horseradish peroxidase) was added to the wells and the plates incubated at RT for an hour. The plates were washed again, and substrate (TMB, 3,3′,5,5′, trimethylbenzidine) incubated in the wells for 30 minutes. Finally, 50 uL 4 NHCL was added and the absorbance read at 620 mu.

1. Cocaine in Hair: Solid-Phase Analyte Enzyme Immunoassay (EIA)

### Example Result for Cocaine by Solid-Phase-Antigen EIA

MS Results**, ng/10 mg
hair

| Sample | Percent* | COC | BE | CE | NOR |
|---|---|---|---|---|---|
| Negative | 100 | | | | |
| (Bo) | | | | | |
| Cutoff (5 ng/ | 53.9 | | | | |
| 10 mg | | | | | |
| hair) | | | | | |
| Positive | 12.5 | 31.6 | 13 | 6.3 | 1.1 |
| Sample | | | | | |
| 59498 | | | | | |
| Positive | 22.3 | 12.7 | 0.7 | 0 | 0 |
| Sample | | | | | |
| 59501 | | | | | |
| Positive | 27.8 | 9.4 | 1.3 | 0 | 0.3 |
| Sample | | | | | |
| 59571 | | | | | |
| Negative | 97.5 | | | | |
| Sample | | | | | |
| 59718 | | | | | |
| Negative | 91.3 | | | | |
| Sample | | | | | |
| 59708 | | | | | |
| Negative | 94.6 | | | | |
| Sample | | | | | |
| 58714 | | | | | |
| Minus | 61.5 | | | | |
| 50% | | | | | |
| control | | | | | |
| Plus 50% | 44 | | | | |
| control | | | | | |

*Note: Percent B/Bo for EIA -- The Negative (Bo) value of 100% is the reference tube containing no analyte in the sample and exhibits maximum binding of antibody to antigen. Unknown samples are expressed as percent of the Negative Bo, termed “Percent B/Bo.” Concentrations of analyte in the samples vary inversely with Percent B/Bo values. A positive sample is one containing drug equal to or more than the cutoff calibrator and thus a Percent B/Bo equal to or lower than the cutoff calibrator.
**COC = cocaine; BE = benzoylecgonine; CE = cocaethylene; NOR = norcocaine

2. Opioids in Hair: Solid-Phase Antigen Enzyme Immunoassay

### Example Result for Opioids by Solid-Phase Analyte EIA

| | | MS Results**, ng/10 mg hair | | | |
|---|---|---|---|---|---|
| Sample | Percent* | Codeine | Morphine | MAM | Oxycodone |
| Negative | 100 | | | | |
| (Bo) | | | | | |
| Cutoff | 43.9 | | | | |
| (2 ng/10 mg | | | | | |
| hair) | | | | | |
| Positive | 7.7 | 0.8 | 7.9 | 7.8 | 0.3 |
| Sample | | | | | |
| 59028 | | | | | |
| Positive | 13.3 | 3.6 | 48.8 | 85.4 | 0.8 |
| Sample | | | | | |
| 58641 | | | | | |
| Positive | 11.9 | 4.3 | 21.3 | 5.4 | 0 |
| Sample | | | | | |
| 58714 | | | | | |
| Negative | 92.8 | | | | |
| Sample | | | | | |
| 42621 | | | | | |
| Negative | 98.2 | | | | |
| Sample | | | | | |
| 42625 | | | | | |
| Negative | 93.6 | | | | |
| Sample | | | | | |
| 42644 | | | | | |
| Minus | 66.3 | | | | |
| 50% | | | | | |
| control | | | | | |
| Plus 50% | 28.9 | | | | |
| control | | | | | |

**MAM = 6-monoacetylmorphine

3. Methamphetamine/MDMA in Hair: Solid-Phase Analyte Enzyme Immunoassay

### Example Result for Methamphetamine/MDMA (Ecstasy) by Solid-Phase Analyte EIA

| | | MS Results**, ng/10 mg hair | | | |
|---|---|---|---|---|---|
| Sample | Percent* | METH | AMP | MDMA | MDA |
| Negative | 100 | | | | |
| (Bo) | | | | | |
| Cutoff | 49 | | | | |
| (5 ng/10 mg | | | | | |
| hair) | | | | | |
| Positive | 11.3 | 2.6 | 0 | 214 | 6.7 |
| Sample | | | | | |
| 59708 | | | | | |
| Positive | 14.4 | 26.9 | 3.8 | 0 | 0 |
| Sample | | | | | |
| 59714 | | | | | |
| Positive | 47.2 | 6.7 | 0.7 | 0 | 0 |
| Sample | | | | | |
| 59718 | | | | | |
| Negative | 100.5 | | | | |
| Sample | | | | | |
| 42625 | | | | | |
| Negative | 102.2 | | | | |
| Sample | | | | | |
| 42642 | | | | | |
| Negative | 97.9 | | | | |
| Sample | | | | | |
| 42655 | | | | | |
| Minus | 67.2 | | | | |
| 50% | | | | | |
| control | | | | | |
| Plus 50% | 39 | | | | |
| control | | | | | |

**METH = methamphetamine; AMP = amphetamine; MDA = 3,4-methylenedioxyamphetamine; MDMA = 3,4-methylenedioxymethamphetamine

### Example 2

### Methanol Extraction of Analytes from Hair and Detection of Multiple Analytes Using Solid Phase Compositions Having Multiple Analytes Bound Thereto

Hair samples were analyzed for the presence of multiple analytes (e.g., drugs of abuse) using methanolic extraction methods as disclosed in Yegles, et al., in: Analytical and Practical Aspects of Drug Testing in Hair, CRC Press, 2007, pp. 73-94; Jurado, C. in: Analytical and Practical Aspects of Drug Testing in Hair, CRC Press, 2007, pp. 95-125; Cheze, M. et al. in: Analytical and Practical Aspects of Drug Testing in Hair, CRC Press, 2007, pp. 163-185). Once extracted, the test samples were evaluated for the presence of multiple drug of abuse analytes using the methods and compositions disclosed herein, e.g., contacted with a solid phase having bound thereto two or more analytes and with one or more primary antibodies, each specific for a particular analyte; each primary antibody is then detected, e.g., through a label on the primary antibody or through detection of the primary antibody via a labeled secondary antibody.

### I. Solutions

Acidified Methanol: Methanol with 1% HCl.

### II. Treatment Procedure for Analyte Extraction for Enzyme Immunoassay

Two mL acidified Methanol was added to 10-12 mg hair in screw-cap glass tubes. Tubes were incubated at 60° C. overnight (16 hours). The methanol was removed into a clean tube and the hair dried by evaporation in a heat block at 50° C. Dried samples were reconstituted in PBS to a hair concentration of 10 mg hair/mL PBS.

### III. Enzyme Immunoassay Using Multi-Analyte-Coated Microplates and Using Methanol Extracts of Hair: Cocaine, Opioids, Amphetamines

FOR EIA, all reagents are filtered to avoid bacterial contamination.

A. Preparation of Microplates: Coating with BSA Analyte Conjugates—COMBO Plate

Microplates were prepared as described above in Example LIMA.

B. Analysis

The analysis of the extract was performed in the same manner as analysis of digest samples.

1. Cocaine in Hair: Solid-Phase Analyte Enzyme Immunoassay Using Methanol Extraction

### Example Result for Cocaine by Solid-Phase Analyte EIA

| | | | MS Results, ng/10 mg hair | | | |
|---|---|---|---|---|---|---|
| | | | sample | | | |
| Sample | Percent | Result | COC | BE | CE | NOR |
| Negative | 100 | | | | | |
| (Bo) | | | | | | |
| Cutoff (5 ng/ | 41.5 | | | | | |
| 10 mg | | | | | | |
| hair) | | | | | | |
| Positive | 3.0 | POS | 174.1 | 14.5 | 20.9 | 2.5 |
| Sample | | | | | | |
| 60303 | | | | | | |
| Positive | 3.6 | POS | 118.7 | 33.5 | 0 | 2.3 |
| Sample | | | | | | |
| 60304 | | | | | | |
| Positive | 4.9 | POS | 70.5 | 26.8 | 0.2 | 2.3 |
| Sample | | | | | | |
| 60312 | | | | | | |
| Positive | 8.3 | POS | 26 | 6.1 | 2.3 | 0.4 |
| Sample | | | | | | |
| 60373 | | | | | | |
| Negative | 92.8 | | | | | |
| Sample | | | | | | |
| 42642 | | | | | | |
| Negative | 85.6 | | | | | |
| Sample | | | | | | |
| 42647 | | | | | | |
| Negative | 87.4 | | | | | |
| Sample | | | | | | |
| 42650 | | | | | | |
| Negative | 90.2 | | | | | |
| Sample | | | | | | |
| 42677 | | | | | | |
| Negative | 94.0 | | | | | |
| Sample | | | | | | |
| 42777 | | | | | | |
| Minus 50% | 53.1 | | | | | |
| control | | | | | | |
| (2.5 ng/ | | | | | | |
| 10 mg | | | | | | |
| hair) | | | | | | |
| Plus 50% | 36.1 | POS | | | | |
| control | | | | | | |
| (7.5 ng/ | | | | | | |
| 10 mg | | | | | | |
| hair) | | | | | | |

2. Opioids in Hair: Solid-Phase Analyte Enzyme Immunoassay Using Methanol Extraction

### Example Result for Opioids by Solid-Phase Analyte EIA

| | Per- | | MS Results, ng/10 mg hair sample | | | |
|---|---|---|---|---|---|---|
| | cent | Result | Codeine | Morphine | 6-MAM | Oxycodone |
| Negative | 100 | | | | | |
| (Bo) | | | | | | |
| Cutoff | 29.6 | | | | | |
| (2 ng/ | | | | | | |
| 10 mg | | | | | | |
| hair) | | | | | | |
| Positive | 5.7 | POS | 0 | 10.5 | 38.9 | 71 |
| Sample | | | | | | |
| 60370 | | | | | | |
| Positive | 27.3 | POS | 2.2 | 1.8 | 0 | 1 |
| Sample | | | | | | |
| 60575 | | | | | | |
| Positive | 16.4 | POS | 0.4 | 1.5 | 3.7 | 0 |
| Sample | | | | | | |
| 60482 | | | | | | |
| Negative | 108.8 | | | | | |
| Sample | | | | | | |
| 42642 | | | | | | |
| Negative | 105.7 | | | | | |
| Sample | | | | | | |
| 42647 | | | | | | |
| Negative | 88.9 | | | | | |
| Sample | | | | | | |
| 42650 | | | | | | |
| Negative | 105.7 | | | | | |
| Sample | | | | | | |
| 42677 | | | | | | |
| Negative | 112.1 | | | | | |
| Sample | | | | | | |
| 42777 | | | | | | |
| Minus | 47.7 | | | | | |
| 50% | | | | | | |
| control | | | | | | |
| (2.5 ng/ | | | | | | |
| 10 mg | | | | | | |
| hair) | | | | | | |
| Plus 50% | 20.1 | POS | | | | |
| control | | | | | | |
| (7.5 ng/ | | | | | | |
| 10 mg | | | | | | |
| hair) | | | | | | |

3. Methamphetamine/MDMA in Hair: Solid-Phase Analyte Enzyme Immunoassay Using Methanol Extraction

### Example Result for Methamphetamine/MDMA (Ecstasy) by Solid-Phase Analyte EIA

| | | | MS Results, ng/10 mg hair | | | |
|---|---|---|---|---|---|---|
| | Percent | Result | Meth | Amp | MDMA | MDA |
| Negative | 100 | | | | | |
| (Bo) | | | | | | |
| Cutoff (5 ng/ | 46.7 | | | | | |
| 10 mg | | | | | | |
| hair) | | | | | | |
| Positive | 25.4 | POS | 17.5 | 0.8 | | |
| Sample | | | | | | |
| 60320 | | | | | | |
| Positive | 12.9 | POS | 22.8 | 0.8 | 120 | 21 |
| Sample | | | | | | |
| 60360 | | | | | | |
| Positive | 25.4 | POS | 15 | 2.6 | | |
| Sample | | | | | | |
| 60435 | | | | | | |
| Positive | 20.3 | POS | 3.3 | 0.1 | 182.1 | 8.9 |
| Sample | | | | | | |
| 60448 | | | | | | |
| Negative | 92.2 | | | | | |
| Sample | | | | | | |
| 42642 | | | | | | |
| Negative | 94.1 | | | | | |
| Sample | | | | | | |
| 42647 | | | | | | |
| Negative | 94.1 | | | | | |
| Sample | | | | | | |
| 42650 | | | | | | |
| Negative | 95.7 | | | | | |
| Sample | | | | | | |
| 42677 | | | | | | |
| Negative | 95.3 | | | | | |
| Sample | | | | | | |
| 42777 | | | | | | |
| Minus 50% | 54 | | | | | |
| control | | | | | | |
| (2.5 ng/10 mg | | | | | | |
| hair) | | | | | | |
| Plus 50% | 41.4 | POS | | | | |
| control | | | | | | |
| (7.5 ng/10 mg | | | | | | |
| hair) | | | | | | |

### IV. Enzyme Immunoassay (Chemiluminescent) Methods for Detecting Drugs of Abuse Using Analyte-Coated Microplates and 0.01 M Phosphate Buffer, pH 6 Washes of Hair

### Analysis of Cocaine in Washes by Chemiluminescent EIA

### 1.0 Principle

The kinetics of removal of drugs of abuse from hair samples using extended multiple exposures to 0.01 M Phosphate Buffer, pH 6, have been studied with thousands of drug positive hair samples in this laboratory. [(1) Baumgartner, et al. Hair Analysis for Organic Analytes: Methodology, Reliability Issues, and Field Studies. In: Drug Testing in Hair, P. Kintz, ed., 1996, pp. 223-265. (2) Baumgartner et al: Hair Analysis for Drugs of Abuse: Decontaminations Issues. In: Recent Developments in Therapeutic Drug Monitoring and Clinical Toxicology, Irving Sunshine, ed. Marcel Dekker, NY., 1992, pp. 577-597. (3) W. A. Baumgartner, V. A. Hill. Sample Preparation Techniques, Forensic Sci. Int 63 (1993) 121-135.] Analysis of the content of the last of a series of washes, and application of criteria regarding the amount of drug in the last wash relative to the drug content of the hair is part of Psychemedics' procedure for confirmatory analyses of presumptive positive hair samples.

The EIA analysis for Cocaine in wash solution is based upon the competitive binding to Cocaine specific primary antibody of Cocaine and metabolites in the sample solution and Benzoylecgonine bound to the wall of the microplate well. After incubation with primary antibody and washing, a second antibody-HRP (Horseradish Peroxidase) conjugate is added to the wells and incubated. The wells are washed again and chemiluminescent substrate is added, and the plates are read in a luminescence reader. A standard curve using Cocaine is prepared against which unknown samples are interpolated to quantitate the amount of Cocaine equivalents in the wash sample. The more analyte is in the sample, the less primary antibody will be bound to the solid-phase antigen, thereby resulting in less binding of HRP-labeled secondary antibody; the RLUs (relative light units) produced by the action of HRP on the substrate are inversely proportional to the amount of Cocaine and metabolites in the sample.

### 2.0 Procedure

Reagents

HAIR WASH BUFFER. This is the Wash Buffer used for washing hair samples in preparing them for confirmation procedures
Cocaine Standard STOCK Solutions 2 ng/100 μL=20 ng/mL and 20 ng/100 μL=200 ng/mL

### Cocaine Standard WORKING Solutions:

| | Volume | VOLUME | Pg/50 uL |
|---|---|---|---|
| STD # | Stock STD | WASH BUFFER | or pg/well |
| B₀ | 0 | 4 | 0 |
| 1 | 80 uL of | 3.92 | 20 |
| | 20 ng/mL | | |
| 2 | 200 uL of | 3.80 | 50 |
| | 20 ng/mL | | |
| 3 | 40 uL of | 3.96 | 100 |
| | 200 ng/mL | | |
| 4 | 80 uL of | 3.92 | 200 |
| | 200 ng/mL | | |
| 5 | 200 uL of | 3.8 | 500 |
| | 200 ng/mL | | |
| 6 | 400 uL of | 3.6 | 1000 |
| | 200 ng/mL | | |

Cocaine Control STOCK Solution 2 ng/100 μL=20 ng/mL and 20 ng/100 uL=200 ng/mL.

### Cocaine Controls WORKING Solutions

| | Volume | VOLUME | Pg/50 uL |
|---|---|---|---|
| CONTROL | Stock Control | WASH BUFFER | or pg/well |
| Low | 240 uL of | 5.76 | 40 |
| | 20 ng/mL | | |
| High | 240 uL of | 5.76 | 400 |
| | 200 ng/mL | | |

First Antibody: Mouse anti-Cocaine antibody for wash assay, 1:8,000 in Ab1 Diluent

### Assay Wash Buffer (0.01 M Phosphate, pH 7)

Goat anti-mouse-HRP conjugate, 1:300,000 dilution in 0.01 M PO₄ containing 0.1% Casein.
Prepared DAILY by dilution of Cocaine Screen Antibody 2.

To prepare 50 mL of 1:300,000 Anti-mouse AB2-HRP, add the following volumes of Anti-mouse AB2-HRP to 50 mL of AB2-HRP diluent:

| | Volume of |
|---|---|
| Dilution of | Cocaine AB2-HRP |
| Cocaine AB2-HRP | (mL) |
| 1:2500 | 0.43 |
| 1:5000 | 0.85 |
| 1:7500 | 1.2 |
| 1:10,000 | 1.7 |

1. SuperSignal Femto Maximum Sensitivity Substrate (obtained from ThermoFisher Pierce)

### Supplies and Equipment

1. Combo (COPA) microplates for Chemiluminescent Wash Assays
2. Pipette equipment
a. May be performed manually, using MLA pipettes, calibrated according to SOP for calibrations of pipettes.
b. May also be performed using the Perkin Elmer Multiprobe Liquid Handling System.
   3. Plate mixer
   4. Plate rotator
   5. Biotek Plate washer/pipettors and reader

### 3.0 Arrangement of Standards, Controls, and Samples in Assay

Arrange the Standards, Controls and unknown samples in a “delta rack” in an 8×12 configuration.

Scanning Standards, Controls, and Samples to Create a Batch
1. With the mouse, click on the “Wash Worklist” icon on computer desktop.
2. Click “List Current”
3. Identify Repeat and Retest samples from previous assays, to add these samples to the current assay.
4. Click “CREATE EIA”
5. ENTER ID/password
6. Scan RACK barcode. (By convention Cocaine wash assays are always Batches 1-5 for the day.)
7. Click on CLOSE
8. Click on the Batch that has just been created.
9. Click SCAN
10. Scan in the batch of samples, standards, controls, and unknowns, by passing the barcode on each tube in front of the scanner.
11. Click SEAL

### 4.0 Assay For Cocaine in Washes of Hair Samples

1. Add 50 uL of each sample to the corresponding well of the Combo (COPA) microplate for Chemiluminescent Wash Assays using an 8-tip MP2 Multiprobe or Janus:

a. Select program Delta Rack to plate 50 uL

b. Place delta rack with samples in position on deck indicated by the program.

c. Place white combo COPA microplate in position on deck indicated by the program.

d. Click Execute and enter the total number of samples.
2. Place microplate containing samples on 96 tip Janus in position indicated by Program 100 uL 1 Drug Ab1 Addition. Place Antibody 1 reservoir in position indicated by Program a. Click RUN.
3. Carefully remove the plate from the deck and cover it with wide cellophane tape to prevent evaporation. Place the plate into the plate tower on the Titer Plate Shaker, setting 2. Allow the plate to shake for 1 hour at room temperature.
4. After the incubation, carefully remove the tape and use program 05 Bottle B 1× Wash on the Biotek ELx405 (Serial#: 256389), wash the plate with 0.01 M PO₄. Select Main Menu, Run, search for program 05 by pressing the Option key or typing in the number.
5. Using program 100 μL 1 Drug AB2 addition.mpt, add 100 μL Cocaine AB₂ to each well. Cover the plate with tape and place it into the plate tower on the Titer Plate Shaker, setting 3. Allow the plate to shake for 1 hour at room temperature.
6. After the incubation, carefully remove the tape and use program 07 Bottle B 2× Wash on the Biotek ELx405 (Serial#: 200979) to wash the plate with 0.01 M PO₄. Select Main Menu, Run, search for program 07 by pressing the Option key or typing in the number.
7. Using program 1004 substrate addition to 1 plate.mpt, add 100 μL chemiluminescent substrate to each well.
8. Read the Plate and Acquire Results

a. Verify matching of worklist and plate
1) Click Icon: Verify
2) A Dialog box for verification will open
3) Scan the Batch-Drug verificati0 on barcode on the worklist.
4) Scan the barcode on the plate
5) The dialog box must turn GREEN and give the go-ahead sound to indicate that the worklist and plate are correctly matched.

b. Click on Gen5 Program from the desktop of the computer

1) Open the protocol “Cocaine Wash Protocol”

2) Click READ icon (delete previous batch information if present)

3) Place cursor in Plate ID and scan the long “Verification Code” on Worklist

4) Move Cursor to Barcode and scan “Last LAN” on worklist

5) Click READ

6) Place plate on carrier.

7) Click OK

### 5.0 Editing The Standard Curve

If there is an outlier among the values of the B₀ and standards, this may be ignored in the data reduction by performing the following editing:

1. Click “MASK” at the bottom left corner of the screen
2. Click on the cell to be masked; asterisks will appear around the value.

### 3. Click “APPLY”

### 4. Click “PRINT”

5. Click File Export (sends data to Export File)

### 6.0 Importing the Results to the Computer Worklist

1. With the mouse, click on “Wash Worklist” on computer desktop.
2. Click on “List in Review”
3. Click on BATCH to select assay.
4. Click on REVIEW.
5. Click on “Import Results” and enter the first RLU.
6. If the curve was edited, note the times on the batches and select the correct version.
7. Any samples known to technician to need repeating, such as indicated on an MFR, this is noted as follows:

a. Click on EDIT icon

b. Type position of sample

c. Click TEST REQUEST drop-down

d. Choose REPEAT option

e. Close window
8. Click on SEAL.
9. Review results.
   a. If results indicate that a dilution of the sample is required, this will be indicated by “Retest 1:10. If a sample is “high-out,” (B/B₀>120), it will be repeated the next day and is indicated “Repeat.”
   b. Analyst may also indicate a sample as a “Repeat” if it is known that an error was made and the sample requires repeating.
   c. Analyst must check the Prev Req column to check that dilutions are noted correctly.
   d. These samples will be kept in an “incomplete” pool in the computer and in the laboratory, and repeated the next day using either no dilution (repeat) or a 1:10 dilution (retest) of the sample in wash buffer
10. Results are reviewed by the Positive Certifying Scientist.

### Analysis of Methamphetamine/MDMA in Washes by Chemiluminescent EIA

### 1.0 Principle

The EIA analysis for Methamphetamines in wash solution is based upon the competitive binding to methamphetamine-specific primary antibody of methamphetamines in the sample solution and methamphetamine bound to the wall of the microplate well. After incubation with primary antibody and washing, a second antibody-HRP (horseradish peroxidase) conjugate is added to the wells and incubated. The wells are washed again and chemiluminescent substrate is added, and the plates are read in a luminescence reader. A standard curve using methamphetamine calibrators is prepared against which unknown samples are interpolated to quantitate the amount of methamphetamine equivalents in the wash sample. The more methamphetamines is in the sample, the less primary antibody will be bound to the solid-phase antigen, thereby resulting in less binding of HRP-labeled secondary antibody; the RLUs (relative light units) produced by the action of HRP on the substrate are inversely proportional to the amount of methamphetamine equivalents in the sample.

### 2.0 Procedure

### Reagents

HAIR WASH BUFFER. This is the Wash Buffer used for washing hair samples in preparing them for confirmation procedures
Methamphetamine Standard STOCK Solutions 0.85 ng/100 μL=8.5 ng/mL and 8.4 ng/=84 ng/mL

Methamphetamine Standard WORKING Solutions:

| | | VOLUME HAIR | |
|---|---|---|---|
| | | WASH BUFFER | Pg/50 uL or |
| STD # | Volume Stock STD | (mL) | pg/well |
| B₀ | 0 | 4.0 | 0 |
| 1 | 80 uL of 8.5 ng/mL | 3.92 | 8.5 |
| 2 | 200 uL of 8.5 ng/mL | 3.80 | 21 |
| 3 | 400 uL of 8.5 ng/mL | 3.60 | 42 |
| 4 | 80 uL of 84 ng/mL | 3.92 | 85 |
| 5 | 200 uL of 84 ng/mL | 3.80 | 210 |
| 6 | 400 uL of 84 ng/mL | 3.60 | 420 |

Methamphetamine Control STOCK Solutions 2.4 ng/100 mL=24 ng/mL and 16.7 ng/100 uL=167 ng/mL.

Methamphetamine Controls WORKING Solutions

| | | VOLUME HAIR | |
|---|---|---|---|
| | Volume Stock | WASH BUFFER | Pg/50 uL or |
| CONTROL | Control | (mL) | pg/well |
| LPOS | 120 uL of 24 ng/mL | 5.88 | 24 |
| POS | 120 uL of 167 ng/mL | 5.88 | 167 |

First Antibody: Goat anti-methamphetamine antibody for wash assay

Assay Wash Buffer (0.01 M Phosphate)

Rabbit anti-goat-HRP conjugate.

SuperSignal Femto Maximum Sensitivity Substrate (obtained from ThermoFisher Pierce)

### Supplies and Equipment

Combo (COPA) microplates for Chemiluminescent Wash Assays

Pipette equipment
May be performed manually, using MLA pipettes, calibrated according to SOP for calibrations of pipettes.
May also be performed using the Perkin Elmer Multiprobe Liquid Handling System or Perkin Elmer Janus MDT.

Plate mixer

Plate rotator

Biotek Plate washer/pipettors and reader

### Assay for Methamphetamine/Mdma in Washes of Hair Samples

1. Add 50 uL of each sample to the corresponding well of the Combo (COPA) microplate for Chemiluminescent Wash Assays using an 8-tip MP2 Multiprobe or Janus:

a. Select program Delta Rack to plate 50 uL

b. Place delta rack with samples in position on deck indicated by the program.

c. Place white combo COPA microplate in position on deck indicated by the program.

d. Click Execute and enter the total number of samples.
2. Place microplate containing samples on 96 tip Janus in position indicated by Program 100 uL 1 Drug Ab1 Addition. Place Antibody 1 reservoir in position indicated by Program a. Click RUN.
3. Carefully remove the plate from the deck and cover it with wide cellophane tape to prevent evaporation. Place the plate into the plate tower on the Titer Plate Shaker, setting 2. Allow the plate to shake for 1 hour at room temperature.
4. After the incubation, carefully remove the tape and use program 05 Bottle B 1× Wash on the Biotek ELx405 (Serial#: 256389), wash the plate with 0.01M PO₄. Select Main Menu, Run, search for program 05 by pressing the Option key or typing in the number.
5. Using program 100 μL 1 Drug AB2 addition.mt, add 100 μL Methamphetamine AB₂ to each well. Cover the plate with tape and place it into the plate tower on the Titer Plate Shaker, setting 3. Allow the plate to shake for 1 hour at room temperature.
6. After the incubation, carefully remove the tape and use program 07 Bottle B 2× Wash on the Biotek ELx405 (Serial#: 200979) to wash the plate with 0.01M PO₄. Select Main Menu, Run, search for program 07 by pressing the Option key or typing in the number.
7. Using program 100 μL substrate addition to 1 plate.mpt, add 100 μL chemiluminescent substrate to each well.
8. Read the Plate and Acquire Results

A. Verify matching of worklist and plate
i. Click Icon: Verify
ii. A Dialog box for verification will open
iii. Scan the Batch-Drug verificati0 on barcode on the worklist.
iv. Scan the barcode on the plate
v. The dialog box must turn GREEN and give the go-ahead sound to indicate that the worklist and plate are correctly matched.

B. Click on Gen5 Program from the desktop of the computer
i. Open the protocol Meth WASH Lumin Protocol.xpt
ii. Click READ icon (delete previous batch information if present)
iii. Place cursor in Plate ID and scan the long “Verification Code” on Worklist
iv. Move Cursor to Barcode and scan “Last LAN” on worklist
v. Click READ
vi. Place plate on carrier.
vii. Click OK

### Analysis of Opiates in Washes by Chemiluminescent EIA

The EIA analysis for opiates in wash solution is based upon the competitive binding to Morphine specific primary antibody of opiates in the sample solution and opiates bound to the wall of the microplate well. After incubation with primary antibody and washing, a second antibody-HRP (horseradish peroxidase) conjugate is added to the wells and incubated. The wells are washed again and chemiluminescent substrate is added, and the plates are read in a luminescence reader. A standard curve using morphine as calibrator is prepared against which unknown samples are interpolated to quantitate the amount of morphine-equivalents in the wash sample. The more analyte is in the sample, the less primary antibody will be bound to the solid-phase antigen, thereby resulting in less binding of HRP-labeled secondary antibody; the RLUs (relative light units) produced by the action of HRP on the substrate are inversely proportional to the amount of Morphine-equivalents in the sample.

### Procedure

Reagents

HAIR WASH BUFFER.

Morphine Standard STOCK Solutions 2.5 ng/mL and 25 ng/mL.

Morphine Standard WORKING Solutions:

| | | VOLUME WASH | Pg/50 uL or |
|---|---|---|---|
| STD # | Volume Stock STD | BUFFER (mL) | pg/well |
| B₀ | 0 | 2.0 | |
| 1 | 200 uL of 2.5 ng/mL | 3.8 | 6.25 |
| 2 | 400 uL of 2.5 ng/mL | 3.6 | 12.5 |
| 3 | 64 uL of 25 ng/mL | 3.94 | 20 |
| 4 | 128 uL of 25 ng/mL | 3.87 | 40 |
| 5 | 200 uL of 25 ng/mL | 3.8 | 62.5 |
| 6 | 400 uL of 25 ng/mL | 3.6 | 125 |

Morphine Control STOCK Solution 2 ng/100 μL=20 ng/mL and 8 ng/100 uL=80 ng/mL.

Morphine Controls WORKING Solutions

| | Volume Stock | VOLUME WASH | Pg/50 uL or |
|---|---|---|---|
| CONTROL | Control | BUFFER | pg/well |
| LOW | 84 uL of 20 ng/mL | 5.916 | 14 |
| HIGH | 72 uL of 80 ng/mL | 5.928 | 48 |

First Antibody: Mouse anti-Morphine antibody for Wash Assay

Assay Wash Buffer (0.01 M Phosphate)
Goat anti-mouse-HRP conjugate, 1:75,000 dilution in 0.01 M PO₄ containing 0.1% casein. Prepared DAILY by dilution of Cocaine Screen Antibody 2.

To prepare 50 mL of 1:75,000 Anti-mouse AB2-HRP, add the following volumes of Anti-mouse AB2-HRP to 50 mL of AB2-HRP diluent:

| Dilution of Cocaine | Volume of Cocaine |
|---|---|
| AB2-HRP | AB2-HRP (mL) |
| 1:2500 | 1.67 |
| 1:5000 | 3.33 |
| 1:7500 | 5 |
| 1:10,000 | 6.67 |

SuperSignal Femto Maximum Sensitivity Substrate (obtained from ThermoFisher Pierce)
Supplies and Equipment—as described above.

### Assay for Morphine in Washes of Hair Samples

1. Add 50 uL of each sample to the corresponding well of the Combo (COPA) microplate for Chemiluminescent Wash Assays using an 8-tip MP2 Multiprobe or Janus:
Select program Delta Rack to plate 50 uL
Place delta rack with samples in position on deck indicated by the program.
Place white combo COPA microplate in position on deck indicated by the program.
Click Execute and enter the total number of samples.

2. Place microplate containing samples on 96 tip Janus in position indicated by Program 100 uL 1 Drug Ab1 Addition. Place Antibody 1 reservoir in position indicated by Program
a. Click RUN.

3. Carefully remove the plate from the deck and cover it with wide cellophane tape to prevent evaporation. Place the plate into the plate tower on the Titer Plate Shaker, setting 2. Allow the plate to shake for 1 hour at room temperature.

4. After the incubation, carefully remove the tape and use program 05 Bottle B 1× Wash on the Biotek ELx405 (Serial#: 256389), wash the plate with 0.01M PO₄. Select Main Menu, Run, search for program 05 by pressing the Option key or typing in the number.

5. Using program 100 μL 1 Drug AB2 addition.mpt, add 100 μL Opiate AB₂ to each well. Cover the plate with tape and place it into the plate tower on the Titer Plate Shaker, setting 3. Allow the plate to shake for 1 hour at room temperature.
6. After the incubation, carefully remove the tape and use program 07 Bottle B 2× Wash on the Biotek ELx405 (Serial#: 200979) to wash the plate with 0.01M PO₄. Select Main Menu, Run, search for program 07 by pressing the Option key or typing in the number.
7. Using program 100 μL substrate addition to 1 plate.mpt, add 100 μL chemiluminescent substrate to each well.
8. Read the Plate and Acquire Results

Analysis of Phencyclidine in Washes by Chemiluminescent EIA

### 1.0 Principle

The EIA analysis for PCP in wash solution is based upon the competitive binding to PCP specific primary antibody of PCP in the sample solution and PCP bound to the wall of the microplate well. After incubation with primary antibody and washing, a second antibody-HRP (horseradish peroxidase) conjugate is added to the wells and incubated. The wells are washed again and chemiluminescent substrate is added, and the plates are read in a luminescence reader. A standard curve is prepared, against which unknown samples are interpolated to quantitate the amount of PCP in the wash sample. The more PCP is in the sample, the less primary antibody will be bound to the solid-phase antigen, thereby resulting in less binding of HRP-labeled secondary antibody; the RLUs (relative light units) produced by the action of HRP on the substrate are inversely proportional to the amount of PCP in the sample.

### 2.0 Procedure

Reagents

HAIR WASH BUFFER. This is the Wash Buffer used for washing hair samples in preparing them for confirmation procedures

PCP Standard STOCK Standard Solutions 0.2 ng/100 μL=2 ng/mL and 2 ng/100 μL=20 ng/mL

### PCP Standard WORKING Solutions:

Prepare 4.0 mL of each standard:

| | | VOLUME HAIR | |
|---|---|---|---|
| | | WASH BUFFER | pg/50 uL or |
| STD # | Volume Stock STD | (mL) | pg/well |
| B₀ | 0 | 2.0 | 0 |
| 1 | 80 uL of 2 ng/mL | 3.92 | 2 |
| 2 | 200 uL of 2 ng/mL | 3.80 | 5 |
| 3 | 400 uL of 2 ng/mL | 3.60 | 10 |
| 4 | 80 uL of 20 ng/mL | 3.92 | 20 |
| 5 | 200 uL of 20 ng/mL | 3.80 | 50 |
| 6 | 400 uL of 20 ng/mL | 3.60 | 100 |

PCP Control STOCK Solution (2 ng/100 μL=20 ng/mL).

### PCP Controls WORKING Solutions

Prepare 6 mL of each control:

| | Volume Stock | VOLUME HAIR | Pg/50 uL or |
|---|---|---|---|
| CONTROL | Control | WASH BUFFER | pg/well |
| LOW | 60 uL of 20 ng/mL | 5.94 | 10 |
| HIGH | 300 uL of 20 ng/mL | 5.70 | 50 |

First Antibody: Rabbit anti-PCP antibody for wash assay

### Assay Wash Buffer (0.01 M Phosphate)

Goat anti-rabbit-HRP conjugate
SuperSignal Femto Maximum Sensitivity Substrate (obtained from ThermoFisher Pierce)
Supplies and Equipment—as indicated above.

### Assay for PCP in Washes of Hair Samples

1. Add 50 uL of each sample to the corresponding well of the Combo (COPA) microplate for Chemiluminescent Wash Assays using an 8-tip MP2 Multiprobe or Janus:

Select program Delta Rack to plate 50 uL

Place delta rack with samples in position on deck indicated by the program.

Place white combo COPA microplate in position on deck indicated by the program.

Click Execute and enter the total number of samples.
2. Place microplate containing samples on 96 tip Janus in position indicated by Program 100 uL 1 Drug Ab1 Addition. Place Antibody 1 reservoir in position indicated by Program a. Click RUN.
3. Carefully remove the plate from the deck and cover it with wide cellophane tape to prevent evaporation. Place the plate into the plate tower on the Titer Plate Shaker, setting 2. Allow the plate to shake for 1 hour at room temperature.
4. After the incubation, carefully remove the tape and use program 05 Bottle B 1× Wash on the Biotek ELx405 (Serial#: 256389), wash the plate with 0.01M PO₄. Select Main Menu, Run, search for program 05 by pressing the Option key or typing in the number.
5. Using program 100 μL Drug AB2 addition.mpt, add 100 μL PCP AB₂ to each well. Cover the plate with tape and place it into the plate tower on the Titer Plate Shaker, setting 3. Allow the plate to shake for 1 hour at room temperature.
6. After the incubation, carefully remove the tape and use program 07 Bottle B 2× Wash on the Biotek ELx405 (Serial#: 200979) to wash the plate with 0.01M PO₄. Select Main Menu, Run, search for program 07 by pressing the Option key or typing in the number.
7. Using program 100 μL substrate addition to 1 plate.mpt, add 100 μL chemiluminescent substrate to each well.
8. Read the Plate and Acquire Results

### Other Embodiments

A number of embodiments have been described. Nevertheless, it will be understood that various modifications may be made without departing from the spirit and scope of the disclosure provided herein. Accordingly, other embodiments are within the scope of the following claims.

What is claimed is:

1. A method for determining the presence of an analyte of interest in a hair wash sample comprising:
(a) providing a hair wash sample; and
(b) determining if the analyte of interest is present in the sample using an immunoassay specific for the analyte of interest, wherein the immunoassay is not a radioimmunoassay.

2. The method of claim 1, further comprising determining the amount of analyte present, if the analyte is present.

3. The method of claim 2, wherein the amount of analyte present is determined quantitatively.

4. The method of claim 1, wherein the immunoassay specific for the analyte of interest comprises using an antibody specific for the analyte.

5. The method of claim 4, wherein the antibody is detectably labeled with one or more of a fluorescent, luminescent, or enzymatic label.

6. The method of claim 1, wherein the analyte of interest is a drug of abuse or metabolite thereof.

7. The method of claim 6, wherein the drug of abuse or metabolite thereof is selected from cocaine, benzoylecgonine, cocaethylene, norcocaine, PCP, amphetamine, methamphetamine, cannabinoids, THC, carboxy-THC, heroin, codeine, morphine, 6-monoacetylmorphine (MAM), oxycodone, 3,4-methylenedioxyamphetamine (MDA), 3,4-methylenedioxymethamphetamine (MDMA), ketamine, methadone, khat, bath salts, mescaline, and LSD.

8. The method of claim 1, wherein the analyte of interest is a prescription or over-the-counter medication or a metabolite thereof.

9. The method of claim 8, wherein the prescription or over-the-counter medication or a metabolite thereof is selected from the group consisting of: opioids, steroids, amphetamines, cannabinoids, benzodiazepines, NSAIDS, barbiturates, tricyclics, and ephedrines.

10. The method of claim 1, wherein the hair wash sample is derived from the sixth wash of a hair sample.

11. A method for quantitating the amount of an analyte of interest in a hair wash sample comprising:
(a) providing a hair wash sample; and
(b) quantitating the amount of the analyte of interest present in the sample using an immunoassay specific for the analyte of interest, wherein the immunoassay is not a radioimmunoassay.

12. A method for determining the presence of one or more analytes of interest in a hair wash sample, wherein at least one of the analytes is a drug of abuse or a metabolite thereof, the method comprising:
(a) providing a hair wash sample; and
(b) determining if one or more of the analytes of interest are present in the sample using an immunoassay specific for the one or more analytes of interest, wherein the immunoassay is not a radioimmunoassay.

13. A method for quantitating the amount of an analyte of interest in a hair wash sample, wherein the analyte of interest is a drug of abuse or a metabolite thereof, comprising:
(a) providing a hair wash sample; and
(b) quantitating the amount of the analyte of interest present in the sample using an immunoassay specific for the analyte of interest, wherein the immunoassay is not a radioimmunoassay.

14. A method for determining the presence of one or more analytes of interest in a hair wash sample, wherein at least one of the analytes is a prescription or over-the-counter medication or a metabolite thereof, the method comprising:
(a) providing a hair wash sample; and
(b) determining if one or more of the analytes of interest are present in the sample using an immunoassay specific for the one or more analytes of interest, wherein the immunoassay is not a radioimmunoassay.

15. A method for quantitating the amount of an analyte of interest in a hair wash sample, wherein the analyte of interest is a prescription or over-the-counter medication or a metabolite thereof, comprising:
(a) providing a hair wash sample; and
(b) quantitating the amount of the analyte of interest present in the sample using an immunoassay specific for the analyte of interest, wherein the immunoassay is not a radioimmunoassay.

16. A kit for quantitatively determining the amount of an analyte of interest in a hair wash sample comprising:
(a) a vial comprising a hair wash solution; and
(b) a solid phase composition comprising:
1) an analyte of interest associated with a solid phase support, or
2) an antibody specific for an analyte of interest associated with a solid phase support.
